(19) United States
(12) Patent Application Publication
(10) Pub. No.: US 2026/0091670 A1
(43) Pub. Date: Apr. 2, 2026

(54) IN-VEHICLE DISPLAY DEVICE, IN-VEHICLE DISPLAY METHOD, AND STORAGE MEDIUM

(71) Applicant: Panasonic Automotive Systems Co., Ltd., Kanagawa (JP)

(72) Inventors: Kenta MURAKAMI, Osaka (JP); Tadashi YOSHIDA, Osaka (JP)

(73) Assignee: Panasonic Automotive Systems Co., Ltd., Kanagawa (JP)

(21) Appl. No.: 19/301,434

(22) Filed: Aug. 15, 2025

(30) Foreign Application Priority Data
Sep. 30, 2024 (JP) 2024-170176

(51) Int. Cl. B60K 35/22; B60K 35/81; G06F 3/14; G09G 5/00

(52) U.S. Cl. CPC B60K 35/22; B60K 35/81; G06F 3/1415; G09G 5/006; B60K 2360/151; B60K 2360/563; G09G 2370/06; G09G 2380/10

(57) ABSTRACT

In-vehicle display device causes in-vehicle display terminal provided to vehicle to display one of an in-vehicle image that is an image related to in-vehicle devices provided to vehicle or a terminal image that is an image output from mobile terminal carried by a passenger of vehicle. In-vehicle display device includes: first image obtainer that obtains the terminal image from mobile terminal; second image obtainer that obtains the in-vehicle image from in-vehicle devices; failure detector that detects a render failure in a process of generating the terminal image; and display controller that switches an image to be displayed from the terminal image to the in-vehicle image and causes in-vehicle display terminal to display the in-vehicle image, when failure detector detects the render failure in the process of generating the terminal image.

### DESCRIPTION

### CROSS REFERENCE TO RELATED APPLICATION

The present application is based on and claims priority of Japanese Patent Application No. 2024-170176 filed on September 30, 2024.

### FIELD

The present disclosure relates to an in-vehicle display device, an in-vehicle display method, and a storage medium.

### BACKGROUND

In recent years, next-generation applications that display information from mobile terminals on in-vehicle displays have become increasingly popular. In the next-generation applications, all necessary information from the vehicle is collected on a mobile terminal via in-vehicle devices, full-screen rendering is then performed on the mobile terminal, and the rendered image is encoded and transferred to the in-vehicle display through video streaming for display on the in-vehicle display.

For example, Patent Literature (PTL) 1 discloses a vehicle display device that selects information based on preset selection conditions and displays the selected information on a display unit during a period when communications between an information obtainer and a mobile terminal are not available. The vehicle display device is capable of displaying useful information on the display unit even when communications with the mobile terminal cannot be established.

### CITATION LIST

### PATENT LITERATURE

PTL 1: Japanese Unexamined Patent Application Publication No. 2018-1882

### SUMMARY

However, the above-described vehicle display device according to PTL 1 can be improved upon.

In view of the above, an object of the present disclosure is to provide an in-vehicle display device and the like that is capable of improving upon the above related art.

An in-vehicle display device according to one aspect of the present disclosure is an in-vehicle display device that causes an in-vehicle display terminal provided to a vehicle to display one of an in-vehicle image that is an image related to an in-vehicle device provided to the vehicle or a terminal image that is an image output from a mobile terminal carried by a passenger of the vehicle. The in-vehicle display device includes: a first image obtainer that obtains the terminal image from the mobile terminal; a second image obtainer that obtains the in-vehicle image from the in-vehicle device; a failure detector that detects a render failure in a process of generating the terminal image; and a display controller that switches an image to be displayed from the terminal image to the in-vehicle image and causes the in-vehicle display terminal to display the in-vehicle image, when the failure detector detects the render failure in the process of generating the terminal image.

Moreover, an in-vehicle display method according to one aspect of the present disclosure is an in-vehicle display method for causing an in-vehicle display terminal provided to a vehicle to display one of an in-vehicle image that is an image related to an in-vehicle device provided to the vehicle or a terminal image that is an image output from a mobile terminal carried by a passenger of the vehicle. The in-vehicle display method includes: obtaining, by a first image obtainer, the terminal image from the mobile terminal; obtaining, by a second image obtainer, the in-vehicle image from the in-vehicle device; detecting, by a failure detector, a render failure in a process of generating the terminal image; and switching an image to be displayed from the terminal image to the in-vehicle image and causing, by the display controller, the in-vehicle display terminal to display the in-vehicle image, when the failure detector detects the render failure in the process of generating the terminal image.

Moreover, a storage medium according to one aspect of the present disclosure is a non-transitory computer-readable storage medium having stored thereon a program for causing a computer to execute the in-vehicle display method.

An in-vehicle display device and the like according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1A schematically illustrates a display control system according to an embodiment provided to a vehicle.

FIG. 1B is a block diagram illustrating the display control system according to the embodiment.

FIG. 2 illustrates render failures.

FIG. 3 is another block diagram illustrating the display control system according to the embodiment.

FIG. 4 illustrates images displayed on an in-vehicle display terminal.

FIG. 5 is another block diagram illustrating the display control system according to the embodiment.

FIG. 6 is a sequence diagram illustrating operation example 1 of the display control system.

FIG. 7 is a sequence diagram illustrating operation example 2 of the display control system.

FIG. 8 is a sequence diagram illustrating operation example 3 of the display control system.

FIG. 9 is another block diagram illustrating a display control system according to another variation.

### DESCRIPTION OF EMBODIMENT

An embodiment will be specifically described below with reference to the drawings.

The embodiment described below shows a general or specific example. Numerical values, shapes, materials, structural elements, the arrangement and connection of the structural elements, steps, the order of the steps, and the like shown in the following embodiment are examples, and are not intended to limit the present disclosure. Among the structural elements in the following embodiment, structural elements which are not recited in the independent claim are described as optional structural elements.

The drawings are schematic views and are not exactly illustrated. In the drawings, substantially the same configurations are identified with the same reference signs.

### EMBODIMENT

### <Configuration and Function>

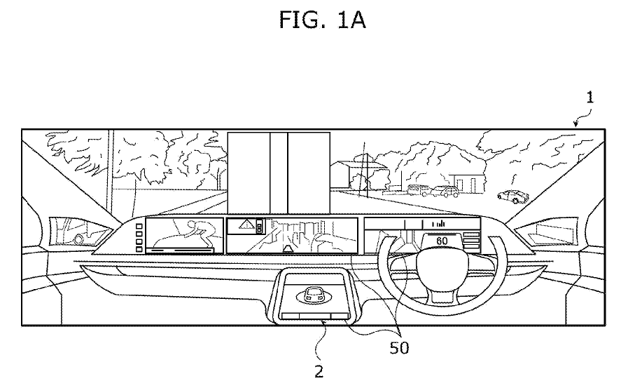

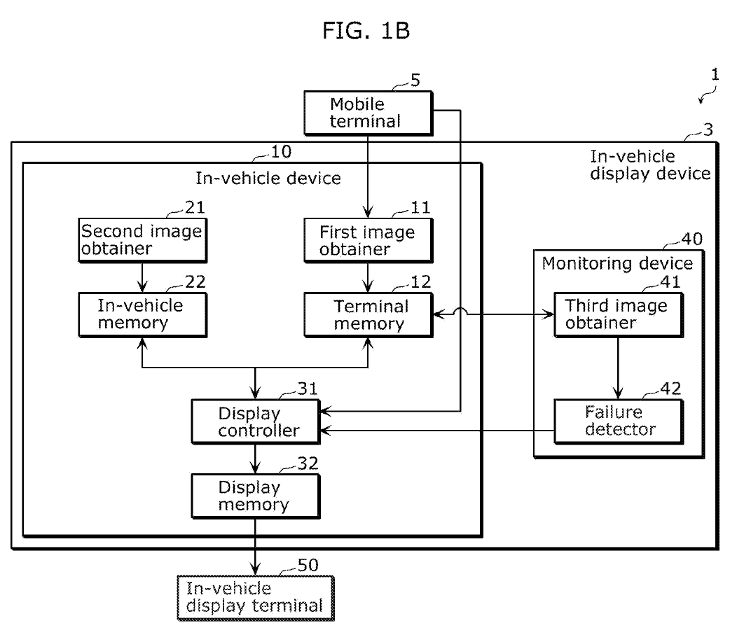

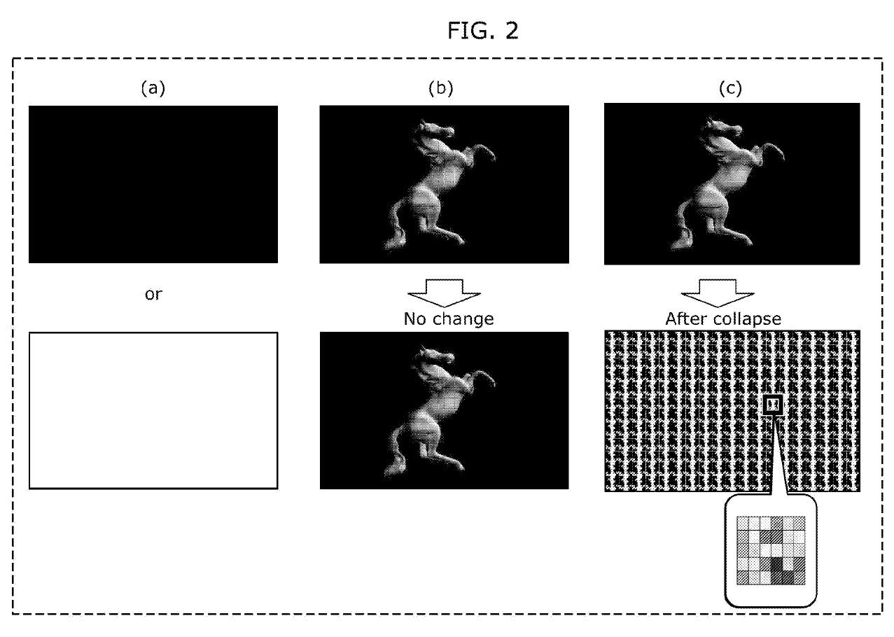

First, a configuration and functions of display control system 1 will be described with reference to FIG. 1A to FIG. 2.

FIG. 1A schematically illustrates display control system 1 according to an embodiment provided to vehicle 2. FIG. 1B is a block diagram illustrating display control system 1 according to the embodiment. FIG. 2 illustrates render failures. In FIG. 2, (a) illustrates a failure that occurs when a rendered frame is plain white or black. In FIG. 2, (b) illustrates a failure that occurs when there is no update. In FIG. 2, (c) illustrates a failure that occurs when a rendered frame is collapsed.

As illustrated in FIG. 1A and FIG. 1B, display control system 1 is a system that is capable of displaying images on one or more in-vehicle display terminals 50 provided in vehicle 2. The images displayed on the one or more in-vehicle display terminals 50 are in-vehicle images that are images related to vehicle 2 or terminal images that are images output by mobile terminal 5. The in-vehicle images and the terminal images include, for example, display information such as images of vehicle instruments, the operating states of vehicle-related devices, navigation information, images captured inside and outside vehicle 2, and surrounding vehicle information. The images of the vehicle instruments are images indicating, for example, a speedometer, a direction indicator light, a warning light, an odometer, a shift position, a fuel gauge, and a water temperature gauge. The vehicle-related devices include, for example, an audio device, an in-vehicle lighting device, and a seat device. The navigation information is information for providing the user with current location and route guidance to the destination during the traveling of vehicle 2. The captured images are images of the surroundings or interior of vehicle 2 captured by an imaging device provided to vehicle 2. The surrounding vehicle information indicates, for example, the presence or absence of other vehicles around vehicle 2, the number of and the speed of such vehicles, and the distance from vehicle 2 to other vehicles.

As illustrated in FIG. 1B, display control system 1 includes in-vehicle display device 3 and in-vehicle display terminal 50.

In-vehicle display device 3 causes in-vehicle display terminal 50 provided to vehicle 2 to display one of an in-vehicle image of in-vehicle device 10 provided to vehicle 2 or a terminal image of mobile terminal 5 carried by a passenger in vehicle 2. For example, when in-vehicle display device 3 is communicatively connected to mobile terminal 5, in-vehicle display device 3 is capable of causing in-vehicle display terminal 50 to display the terminal image of mobile terminal 5. When in-vehicle display device 3 is not communicatively connected to mobile terminal 5, in-vehicle display device 3 is capable of causing in-vehicle display terminal 50 to display the in-vehicle image. In the present embodiment, unless otherwise mentioned, it is assumed that in-vehicle display device 3 is communicatively connected to mobile terminal 5.

Here, mobile terminal 5 is a terminal carried by a passenger of vehicle 2, for example, a smartphone, or a tablet terminal.

In-vehicle display device 3 includes in-vehicle device 10 and monitoring device 40.

In-vehicle device 10 obtains an in-vehicle image or terminal image, and performs a process for causing in-vehicle display terminal 50 to display any of the obtained images.

Specifically, in-vehicle device 10 includes first image obtainer 11, terminal memory 12, second image obtainer 21, in-vehicle memory 22, display controller 31, and display memory 32.

First image obtainer 11 is communicatively connected to mobile terminal 5 to obtain a terminal image from mobile terminal 5. First image obtainer 11 outputs the terminal image obtained from mobile terminal 5 to terminal memory 12 in a format that can be displayed on in-vehicle display terminal 50.

Terminal memory 12 is a storage medium that holds a storage area such as a frame memory (also called buffer or surface) that temporarily stores the terminal image obtained from mobile terminal 5. Terminal memory 12 holds the obtained terminal image. Note that the terminal image obtained from first image obtainer 11 may be rendered in advance by mobile terminal 5 in a format that can be displayed on in-vehicle display terminal 50, and is not limited to the present embodiment.

Here, monitoring device 40 includes third image obtainer 41 and failure detector 42.

Third image obtainer 41 is an input interface for obtaining the terminal image held in terminal memory 12. Third image obtainer 41 outputs the terminal image obtained from terminal memory 12 to failure detector 42.

Failure detector 42 detects a render failure in the process of generating a terminal image. A render failure is an abnormality or malfunction in the rendering in the process of generating the terminal image.

For example, in the process of generating a terminal image, failure detector 42 determines whether each frame in rendering (sometimes referred to as a rendered frame) includes a failure.

Examples of the render failure include the case where the rendered frame is plain white or black, the case where at least a predetermined number of rendered frames include no change (no update), and the case where the rendered frame includes random colors or patterns and the rendered frame is collapsed, as illustrated in (a) to (c) of FIG. 2. In the case where the rendered frame is plain white or black, or where the rendered frame is collapsed, failure detector 42 is capable of easily determining the render failure because the rendered frame is white or black or includes random colors or patterns. In the case where the rendered frames include no change, failure detector 42 is capable of determining the render failure by checking the differences between a reference rendered frame and a rendered frame preceding the reference rendered frame, and determining whether the period of time during which no update occurs in the render frames is longer than or equal to a predetermined period.

As illustrated in FIG. 1B, when failure detector 42 detects a render failure by determining an occurrence of a failure in rendering, failure detector 42 outputs, to display controller 31, information indicating the occurrence of the render failure. On the other hand, when failure detector 42 detects no render failure, failure detector determines that there is no failure occurring in the rendering and outputs, to display controller 31, information indicating that the rendering is normal.

Returning to the description of in-vehicle device 10, second image obtainer 21 of in-vehicle device 10 may be, for example, an input interface that obtains an in-vehicle image from an in-vehicle storage (not illustrated) provided to in-vehicle device 10, or an image generator that obtains an in-vehicle image by generation of the in-vehicle image by a given application. Second image obtainer 21 outputs the obtained in-vehicle image to in-vehicle memory 22.

In-vehicle memory 22 is a storage medium that holds a storage area such as a frame memory (also called a buffer or surface) that temporarily stores the in-vehicle image obtained from second image obtainer 21. In-vehicle memory 22 holds the obtained in-vehicle image.

Display controller 31 obtains the terminal image from terminal memory 12 and obtains the in-vehicle image from in-vehicle memory 22. Display controller 31 outputs any one of the obtained images to display memory 32.

In order to cause in-vehicle display terminal 50 to display the rendered terminal image or the rendered in-vehicle image, display controller 31 outputs the rendered terminal image or the rendered in-vehicle image to display memory 32 and causes in-vehicle display terminal 50 to display the rendered terminal image or the rendered in-vehicle image via display memory 32.

Display controller 31 is capable of switching between the rendered terminal image or the rendered in-vehicle image based on an instruction from mobile terminal 5. In other words, when the passenger who carries mobile terminal 5 operates mobile terminal 5, display controller 31 switches the image to be displayed on in-vehicle display terminal 50 between the rendered terminal image and the rendered in-vehicle image according to the instruction corresponding to the operation.

When failure detector 42 detects a render failure in the process of generating a terminal image, display controller 31 switches from the rendered terminal image to the rendered in-vehicle image and causes in-vehicle display terminal 50 to display the rendered in-vehicle image. Specifically, since mobile terminal 5 is communicatively connected to in-vehicle display device 3, in-vehicle display device 3 outputs the rendered terminal image to in-vehicle display terminal 50. When display controller 31 obtains information indicating an occurrence of a render failure from failure detector 42, display controller 31 switches from the rendered terminal image to the rendered in-vehicle image and causes in-vehicle display terminal 50 to display the in-vehicle image via display memory 32. When display controller 31 obtains information indicating that the rendering is normal from failure detector 42, display controller 31 causes in-vehicle display terminal 50 to continue displaying the rendered terminal image.

Display memory 32 is a storage medium that holds a storage area such as a frame memory (also called buffer or surface) that temporarily stores the terminal image or the in-vehicle image obtained from display controller 31. Display memory 32 outputs the temporarily stored terminal image or in-vehicle image to in-vehicle display terminal 50.

Although not illustrated, display memory 32 may include a frame memory that holds data for overlapping images.

In-vehicle display terminal 50 is an in-vehicle display that is provided to vehicle 2 to display the terminal image or the in-vehicle image output from display memory 32.

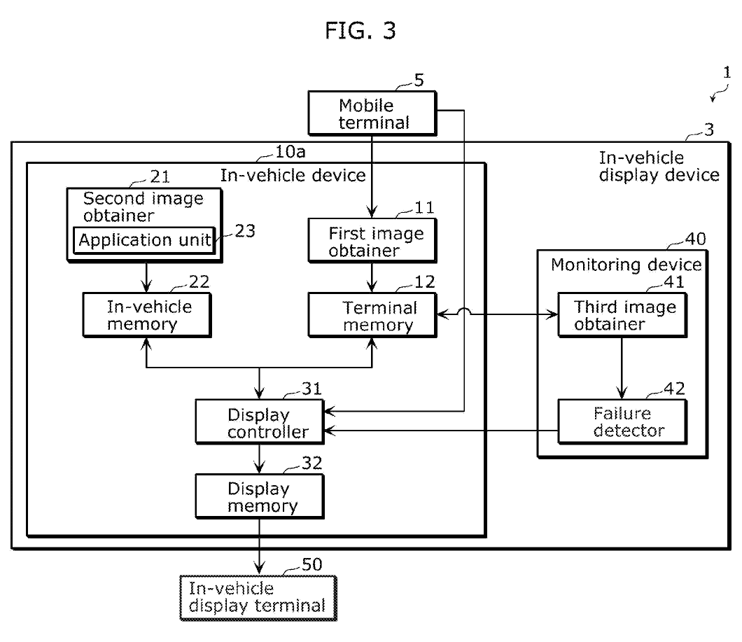

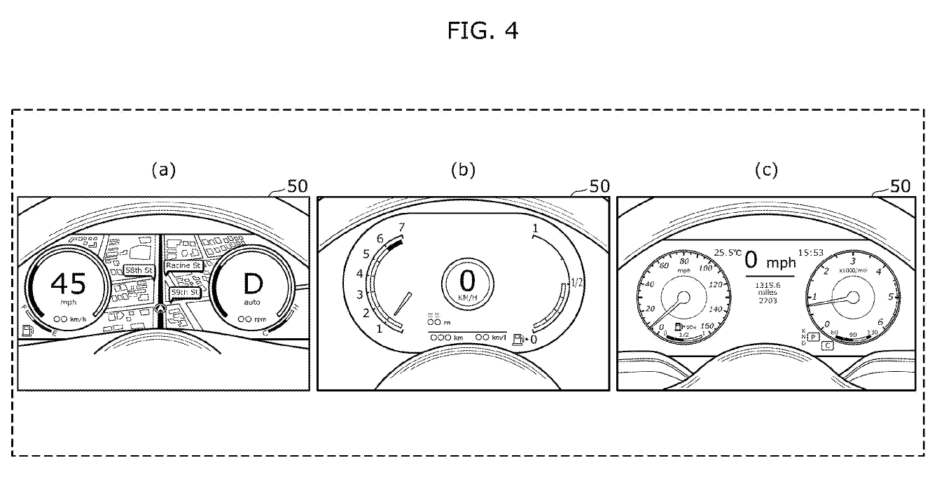

In the present embodiment, as illustrated in FIG. 3 and FIG. 4, in-vehicle display device 3 may further include the following configuration and functions. In-vehicle display device 3 will be described with reference to FIG. 3 and FIG. 4.

FIG. 3 is another block diagram illustrating display control system 1 according to the embodiment. FIG. 4 illustrates the images displayed on in-vehicle display terminal 50. In FIG. 4, (a) illustrates a terminal image. In FIG. 4, (b) illustrates a second in-vehicle image. In FIG. 4, (c) illustrates a first in-vehicle image.

Specifically, as illustrated in FIG. 3, second image obtainer 21 of in-vehicle display device 3 includes application unit 23.

Application unit 23 includes a first application and a second application. Application unit 23 is capable of activating the first application for displaying the first in-vehicle image and the second application for displaying the second in-vehicle image that includes an amount of information less than the amount of information of the first in-vehicle image. The first in-vehicle image and the second in-vehicle image are included in in-vehicle images.

When mobile terminal 5 is not communicatively connected to in-vehicle display device 3, application unit 23 activates the first application. With this, display controller 31 outputs the first in-vehicle image held in in-vehicle memory 22 to in-vehicle display terminal 50 to cause in-vehicle display terminal 50 to display the first in-vehicle image.

On the other hand, when mobile terminal 5 is communicatively connected to in-vehicle display device 3, as described above, after display controller 31 switches the display from the rendered first in-vehicle image to the rendered terminal image and causes in-vehicle display terminal 50 to display the rendered terminal image, application unit 23 may stop the first application and activate the second application. Application unit 23 activates the second application and outputs the second in-vehicle image to display controller 31 via in-vehicle memory 22. At this time, display controller 31 does not output the second in-vehicle image held in in-vehicle memory 22 to in-vehicle display terminal 50, and the second application is running in the background of in-vehicle display device 3. After the second application is fully activated, display controller 31 may switch the display from the rendered first in-vehicle image to the rendered terminal image and then the first application may be stopped.

In this way, display controller 31 switches the display from the rendered first in-vehicle image to the rendered terminal image. By doing so, in-vehicle display terminal 50 is capable of displaying the rendered terminal image, as illustrated in (a) of FIG. 4.

Moreover, when failure detector 42 detects a render failure in the process of generating the terminal image, display controller 31 obtains information indicating the occurrence of the render failure, so that display controller 31 switches from the rendered terminal image to the rendered second in-vehicle image, and causes in-vehicle display terminal 50 to display the rendered second in-vehicle image. In other words, display controller 31 causes in-vehicle display terminal 50 to display the rendered second in-vehicle image, as illustrated in (b) of FIG. 4.

Moreover, when failure detector 42 detects a render failure, after in-vehicle display terminal 50 displays the rendered second in-vehicle image, application unit 23 activates the first application. For example, application unit 23 may activate the first application in response to an instruction from display controller 31 that has obtained information indicating an occurrence of a render failure, or may activate the first application by obtaining information indicating an occurrence of a render failure from monitoring device 40. After the first application is fully activated, display controller 31 switches from the second in-vehicle image held in in-vehicle memory 22 to the first in-vehicle image held in in-vehicle memory 22. Therefore, display controller 31 causes in-vehicle display terminal 50 to display the rendered first in-vehicle image, as illustrated in (c) of FIG. 4. In other words, the second in-vehicle image is displayed to bridge the period of time between when the render failure is detected and when the rendered first in-vehicle image is displayed on in-vehicle display terminal 50 after the first application is fully activated.

As illustrated in FIG. 3, after the first application is fully activated, application unit 23 stops the second application. In this way, the second application that is no longer needed is stopped, so that an increase in resource (processing load, power consumption, etc.) of in-vehicle device 10a can be inhibited.

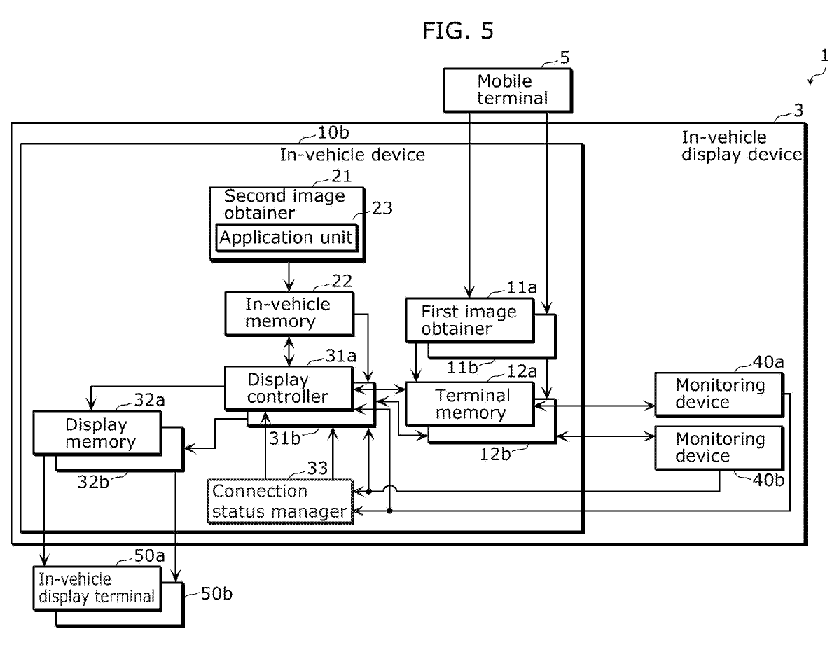

Moreover, in the present embodiment, as illustrated in FIG. 5, in-vehicle display device 3 may further include the following configuration and functions. With reference to FIG. 5, in-vehicle display device 3 will be described.

FIG. 5 is another block diagram illustrating display control system 1 according to the embodiment.

Specifically, in-vehicle display device 3 includes in-vehicle device 10b and a plurality of monitoring devices 40a and 40b. In-vehicle device 10b includes a plurality of first image obtainers 11a and 11b, a plurality of terminal memories 12a and 12b, second image obtainer 21, in-vehicle memory 22, connection status manager 33, a plurality of display controllers 31a and 31b, and a plurality of display memories 32a and 32b. In-vehicle display device 3 may include a plurality of second image obtainers 21 and a plurality of in-vehicle memories 22, and is not limited to the present embodiment.

The plurality of first image obtainers 11a and 11b, the plurality of terminal memories 12a and 12b, the plurality of display controllers 31a and 31b, the plurality of display memories 32a and 32b, and the plurality of monitoring devices 40a and 40b are provided in a one to one correspondence. Vehicle 2 includes a plurality of in-vehicle display terminals 50a and 50b. The plurality of in-vehicle display terminals 50a and 50b correspond to the plurality of display controllers 31a and 31b in a one to one correspondence. In the present embodiment, as an example, two first image obtainers 11a and 11b, two terminal memories 12a and 12b, two display controllers 31a and 31b, two display memories 32a and 32b, and two monitoring devices 40a and 40b are illustrated. Of course, the case where three or more first image obtainers 11, three or more terminal memories 12, three or more display controllers 31, three or more display memories 32, and three or more monitoring devices 40 are included are also included in the present embodiment.

Mobile Terminal 5 outputs terminal images to the plurality of first image obtainers 11a and 11b. The plurality of terminal memories 12a and 12b render, based on the terminal images obtained via the plurality of first image obtainers 11a and 11b, the terminal images in a format that can be displayed on the plurality of in-vehicle display terminals 50a and 50b using a predetermined application, and output the rendered terminal images to the plurality of display controllers 31a and 31b and the plurality of monitoring devices 40a and 40b in a one-to-one correspondence.

Here, each of the plurality of monitoring devices 40a and 40b outputs information indicating an occurrence of a render failure or information indicating that rendering is normal to a corresponding one of display controllers 31a and 31b, based on the results of the determination. The plurality of monitoring devices 40a and 40b output, to connection status manager 33, the results of determining whether each render frame includes a failure in the process of generating the terminal images held by terminal memories 12a and 12b, respectively.

Connection status manager 33 obtains such results from the plurality of monitoring devices 40a and 40b and manages the plurality of display controllers 31a and 31b based on the obtained results. Connection status manager 33 manages display of the rendered terminal images or in-vehicle images on the plurality of in-vehicle display terminals 50a and 50b based on the results output from failure detectors 42 of the plurality of monitoring devices 40a and 40b.

Specifically, connection status manager 33 outputs, to the plurality of display controllers 31a and 31b, instructions to switch from the rendered terminal images to the rendered in-vehicle images, when the number of results each indicating an occurrence of a render failure is greater than or equal to a predetermined threshold value among the results output from failure detectors 42 of the plurality of monitoring devices 40a and 40b. The plurality of display controllers 31a and 31b respectively cause in-vehicle display terminals 50a and 50b to display the in-vehicle images via the plurality of display memories 32a and 32b.

Even when the number of results each indicating an occurrence of a render failure is greater than or equal to the predetermined threshold value and one or more results indicating an occurrence of no render failure are included, all rendered terminal images are replaced with the rendered in-vehicle images because it is considered that a failure is likely to occur in the future.

On the other hand, when the number of results indicating that a render failure has occurred is less than the predetermined threshold value among the plurality of results obtained, connection status manager 33 outputs, to the plurality of display controllers 31a and 31b, instructions not to switch from the rendered terminal images to the rendered in-vehicle images. The plurality of display controllers 31a and 31b cause the plurality of in-vehicle display terminals 50a and 50b to display the rendered terminal images. Therefore, the plurality of display controllers 31a and 31b respectively cause the plurality of in-vehicle display terminals 50a and 50b to display the terminal images via the plurality of display memories 32a and 32b. The predetermined threshold value is, for example, a majority, but not limited to a majority.

In the terminal images held by a given terminal memory 12 of the plurality of terminal memories 12a and 12b, there may be no change in the rendered frames for at least a predetermined period. In this case, when the rendered terminal images include no change for at least a predetermined period and connection status manager 33 obtains, from failure detector 42, a result indicating a detection of an occurrence of a render failure, and no render failure is indicated by results other than the above result, connection status manager 33 determines that the rendered terminal images simply include no change and no render failure is occurring in the process of generating the terminal image, and causes the plurality of in-vehicle display terminals 50a and 50b to continue displaying the rendered terminal images.

Specifically, connection status manager 33 determines that there is simply no change in the rendered frames when no failure is occurring in terminal memory 12 other than given terminal memory 12, and discards the result obtained from failure detector 42 indicating the occurrence of the render failure. In this case, the plurality of display controllers 31a and 31b cause the plurality of in-vehicle display terminals 50a and 50b to continue displaying the rendered terminal images.

However, when a failure is occurring in terminal memory 12 other than given terminal memory 12, connection status manager 33 outputs, to the plurality of display controllers 31a and 31b, instructions to switch from the rendered terminal images to the rendered in-vehicle images and causes the plurality of in-vehicle display terminals 50a and 50b to display the rendered in-vehicle images. In this case, the plurality of display controllers 31a and 31b switch from the rendered terminal image to the rendered in-vehicle image and cause the plurality of in-vehicle display terminals 50a and 50b to display the rendered in-vehicle images.

Moreover, when connection status manager 33 obtains, from one or more failure detectors 42, results each indicating an occurrence of a render failure, connection status manager 33 may cause the plurality of in-vehicle display terminals 50a and 50b, a notifier such as an acoustic device, and the like provided to vehicle 2 to notify the content of the failure that has occurred. Examples of the content of the failure include that the number of results indicating the occurrence of the render failure is greater than or equal to a predetermined threshold value, and the failure is due to insufficient resources in mobile terminal 5.

Moreover, in the present embodiment, in-vehicle display device 3 may further include the following configuration and functions.

Specifically, failure detector 42 further detects the status of the communication connection between mobile terminal 5 and in-vehicle display device 3. Based on the presence or absence of a render failure in the process of generating the terminal image and the communication connection status, in-vehicle display terminal 50 displays whether the failure is due to a failure in the communication connection status between mobile terminal 5 and in-vehicle display device 3 or a failure in the process of generating the terminal image (failure in terminal memory 12).

More specifically, in the communication connection status where mobile terminal 5 is communicatively connected to in-vehicle display device 3, when failure detector 42 detects an occurrence of a render failure in the process of generating the terminal image, failure detector 42 outputs, to display controller 31, the detection result indicating that the failure is due to a failure in terminal memory 12. Display controller 31 causes in-vehicle display terminal 50 to display information indicating an occurrence of a failure in terminal memory 12. In other words, in-vehicle display terminal 50 displays an occurrence of a render failure in the in the process of generating the terminal image by the in-vehicle image.

On the other hand, in the communication connection status where mobile terminal 5 is not communicatively connected to in-vehicle display device 3, when failure detector 42 detects an occurrence of a render failure in the process of generating the terminal image, failure detector 42 outputs, to display controller 31, the detection result indicating that the failure is due to a failure in the communication connection status. Examples of the communication connection status where mobile terminal 5 is not communicatively connected to in-vehicle display device 3 include the case where the wireless communication connection between mobile terminal 5 and in-vehicle display device 3 is interrupted or intermittently disconnected, and the case where mobile terminal 5 is not communicatively connected to in-vehicle display device 3 although mobile terminal 5 is connected to in-vehicle display device 3 by a communication cable or the like. Display controller 31 causes in-vehicle display terminal 50 to display information indicating an occurrence of a failure in the communication connection status. In other words, in-vehicle display terminal 50 displays that the failure is due to a failure in the communication connection status between mobile terminal 5 and in-vehicle display device 3 by the in-vehicle image.

In the case where failure detector 42 detects whether the failure is due to a failure in the communication connection status between mobile terminal 5 and in-vehicle display device 3 or a render failure in the process of generating the terminal image, the present embodiment is applicable to the case, as illustrated in FIG. 5, where in-vehicle display device 3 includes a plurality of monitoring devices 40a and 40b and in-vehicle device 10b includes a plurality of first image obtainers 11a and 11b, a plurality of terminal memories 12a and 12b, second image obtainer 21, in-vehicle memory 22, connection status manager 33, a plurality of display controllers 31a and 31b, and a plurality of display memories 32a and 32b.

In this case, connection status manager 33 obtains the results of determining whether or not a failure is occurring from the plurality of monitoring devices 40a and 40b, and connection status manager 33 is capable of determining, based on the obtained results, whether the failure is due to a failure in the communication connection status between mobile terminal 5 and in-vehicle display device 3 or a render failure in the process of generating the terminal image. For example, connection status manager 33 may determine that the failure is due to a render failure in the process of generating the terminal image when the number of results each indicating an occurrence of a render failure is less than a predetermined threshold value (approximately several results). Moreover, when connection status manager 33 obtains, from all monitoring devices 40, results each indicating an occurrence of a render failure, connection status manager 33 may determine that the failure is due to a failure in the communication connection status between mobile terminal 5 and in-vehicle display device 3.

### <Operation Example 1>

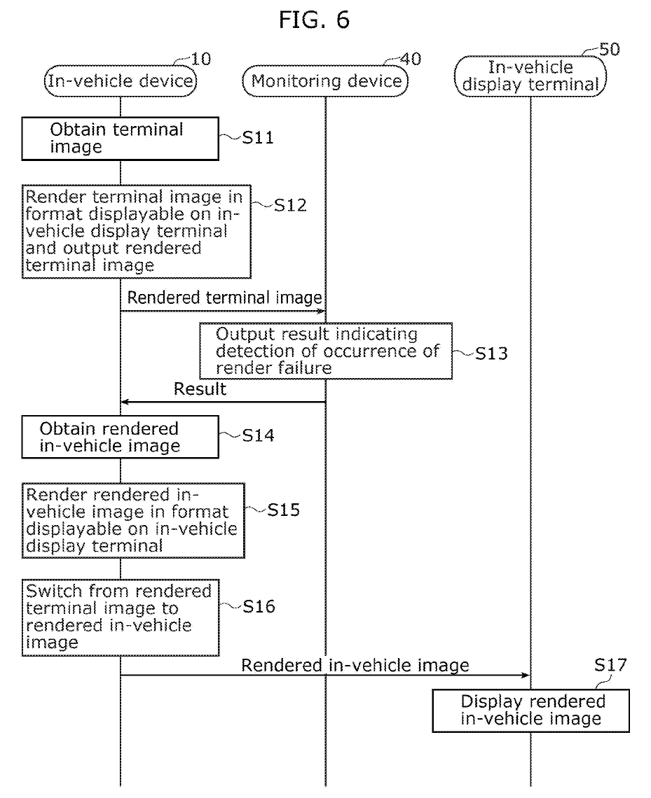

Next, with reference to FIG. 6, operation example 1 of display control system 1 will be described.

FIG. 6 is a sequence diagram illustrating operation example 1 of display control system 1. FIG. 6 assumes a case where a failure has occurred in a terminal image for some reason, such as communication disconnection, during the display of the terminal image.

First, in-vehicle display device 3 is communicatively connected to mobile terminal 5, so that first image obtainer 11 of in-vehicle device 10 obtains a terminal image from mobile terminal 5 (S11).

Next, terminal memory 12 obtains the terminal image from first image obtainer 11, holds the obtained terminal image in the format that can be displayed on in-vehicle display terminal 50, and outputs the terminal image held to display controller 31 and monitoring device 40 (S12).

Next, monitoring device 40 outputs, to display controller 31, the result indicating the detection of a failure occurring in terminal memory 12 (information indicating an occurrence of a render failure) (S13).

Next, second image obtainer 21 of in-vehicle device 10 obtains a rendered in-vehicle image (S14).

Next, in-vehicle memory 22 obtains the in-vehicle image from second image obtainer 21 and renders the obtained in-vehicle image in the format that can be displayed on in-vehicle display terminal 50 (S15). In-vehicle memory 22 outputs the in-vehicle image held to display controller 31.

Steps S14 and S15 may be performed before steps S11 and S12.

Next, since a render failure has been detected by monitoring device 40, display controller 31 switches from the rendered terminal image to the rendered in-vehicle image (S16) and causes in-vehicle display terminal 50 to display the rendered in-vehicle image. In other words, display controller 31 outputs the rendered in-vehicle image to in-vehicle display terminal 50 via display memory 32.

Next, in-vehicle display terminal 50 displays the rendered in-vehicle image (S17).

The processes in the sequence diagram in FIG. 6 then end.

### <Operation Example 2>

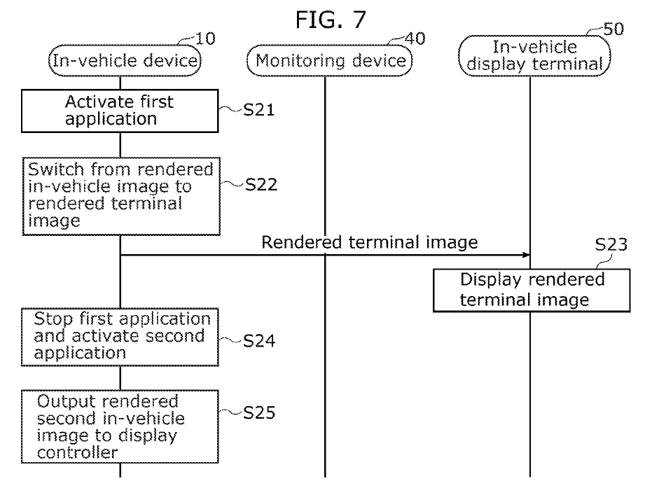

Next, with reference to FIG. 7, operation example 2 of display control system 1 will be described.

FIG. 7 is a sequence diagram illustrating operation example 2 of display control system 1. Operation example 2 in FIG. 7 assumes a case where no render failure has occurred and illustrates an example of an operation performed when mobile terminal 5 changes from a status in which mobile terminal 5 is not communicatively connected to in-vehicle display device 3 to a status in which mobile terminal 5 is communicatively connected to in-vehicle display device 3.

First, when mobile terminal 5 is not communicatively connected to in-vehicle display device 3, application unit 23 activates a first application (S21).

Next, when mobile terminal 5 is communicatively connected to in-vehicle display device 3, display controller 31 switches the display from the rendered in-vehicle image to the rendered terminal image (S22), and causes in-vehicle display terminal 50 to display the rendered terminal image. In other words, display controller 31 outputs the terminal image to in-vehicle display terminal 50 via display memory 32.

Next, in-vehicle display terminal 50 displays the rendered terminal image (S23).

Next, application unit 23 stops the first application and activates a second application (S24). This is because the second application includes a less amount of information, so it is preferable to stop the first application that includes a larger amount of information. By causing the second application, which has less resources than the first application, to run in the background, it can be expected to immediately switch from the terminal image to a second in-vehicle image of the second application even when a failure occurs in rendering of the terminal image. In addition, resource consumption can be reduced in the period of time during which the display of the second application is placed on standby.

Next, application unit 23 activates the second application, renders the second in-vehicle image via in-vehicle memory 22 in a format that can be displayed on in-vehicle display terminal 50, and outputs the rendered second in-vehicle image to display controller 31 (S25). At this time, display controller 31 does not output, to in-vehicle display terminal 50, the second in-vehicle image held in in-vehicle memory 22 by the activation of the second application.

Therefore, when no failure is occurring in terminal memory 12 in the process of generating the terminal image, display controller 31 causes in-vehicle display terminal 50 to continue displaying the rendered terminal image and places the display of the second in-vehicle image rendered based on the second application on standby.

The processes in the sequence diagram in FIG. 7 then ends.

### <Operation Example 3>

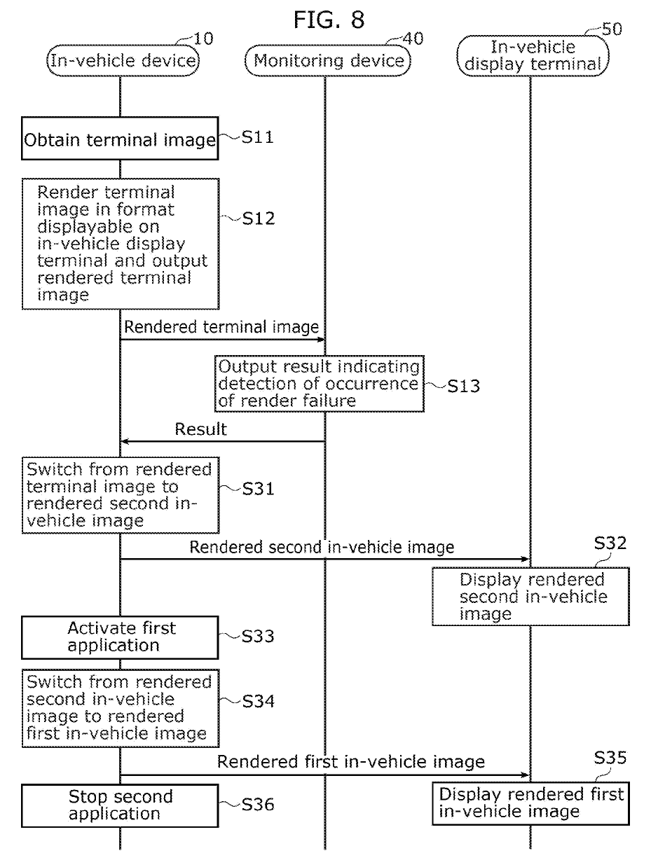

Next, with reference to FIG. 8, operation example 3 of display control system 1 will be described.

FIG. 8 is a sequence diagram illustrating operation example 3 of display control system 1. Operation Example 3 in FIG. 8 illustrates an example of an operation performed when a render failure occurs after operation example 2 illustrated in FIG. 7.

First, when a render failure occurs, the processes (S11 to S13) in operation example 1 of FIG. 6 are executed. When failure detector 42 detects a render failure, the second application has already been activated as illustrated in step S25 in FIG. 7, so that display controller 31 switches from the rendered terminal image to the rendered second in-vehicle image (S31), and causes in-vehicle display terminal 50 to display the rendered second in-vehicle image (S32). Since the second in-vehicle image includes a less amount of information, it is preferable to cause in-vehicle display terminal 50 to display the first in-vehicle image that includes a larger amount of information. Therefore, the second in-vehicle image is displayed on in-vehicle display terminal 50 only for a period of time until the rendered first in-vehicle image can be displayed on in-vehicle display terminal 50.

Next, in order to display the rendered first in-vehicle image on in-vehicle display terminal 50, application unit 23 activates the first application (S33).

The order of steps S31, S32, and S33 may be reversed or performed simultaneously.

Next, after the first application is fully activated, display controller 31 switches from the second in-vehicle image held in in-vehicle memory 22 to the first in-vehicle image held in in-vehicle memory 22 (S34). Display controller 31 causes in-vehicle display terminal 50 to display the rendered first in-vehicle image (S35). This allows in-vehicle display terminal 50 to display the first in-vehicle image including a large amount of information.

Next, application unit 23 stops the second application (S36).

The processes in the sequence diagram in FIG. 8 then end.

### <Operations and Effects>

Next, the operations and effects of in-vehicle display device 3, the in-vehicle display method, and the program according to the present embodiment will be described.

However, although the vehicle display device according to PTL 1 determines the validity of the communication between the information obtainer and the mobile terminal, the vehicle display device does not cover failure patterns such as contact failures of communication lines in wired communication. Moreover, in the vehicle display device according to PTL 1, when a communication with the mobile terminal is disconnected or the like, the information selected based on the preset selection conditions can be displayed on the display unit. However, depending on the selection conditions, the time required to display the selected information on the display unit after the communication disconnection may be prolonged. When the communication is continuously disconnected in the mobile terminal , the information displayed on the vehicle display terminal is not updated for a long period of time, which may endanger the safety of the passenger depending on the content. As a result, when a failure occurs in the display of information provided from the mobile terminal to the passenger via the vehicle display terminal, the information cannot be displayed appropriately.

In view of the above, as described above, in-vehicle display device 3 according to technique 1 of the present embodiment causes in-vehicle display terminal 50 provided to vehicle 2 to display one of an in-vehicle image that is an image related to in-vehicle devices 10, 10a, 10b, 10c provided to vehicle 2 or a terminal image that is an image output from mobile terminal 5 carried by a passenger of vehicle 2. In-vehicle display device 3 includes: first image obtainer 11 that obtains the terminal image from mobile terminal 5; second image obtainer 21 that obtains the in-vehicle image from in-vehicle devices 10, 10a, 10b, 10c; failure detector 42 that detects a render failure in a process of generating the terminal image; and display controller 31 that switches an image to be displayed from the terminal image to the in-vehicle image and causes in-vehicle display terminal 50 to display the in-vehicle image, when failure detector 42 detects the render failure in the process of generating the terminal image.

With this, failure detector 42 detects a render failure. Accordingly, for example, even when mobile terminal 5 loses communication with an external base station or some other problem occurs when rendering a terminal image, it is possible to switch from the terminal image to the in-vehicle image and cause in-vehicle display terminal 50 to display the in-vehicle image.

Accordingly, with in-vehicle display device 3, even when there is a failure in the display of information provided from mobile terminal 5 to the passenger via vehicle display terminal 50, the information can be displayed appropriately.

Moreover, in-vehicle display device 3 according to technique 2 of the present embodiment is in-vehicle display device 3 according to technique 1. In this case, the in-vehicle image includes a first in-vehicle image and a second in-vehicle image. In-vehicle display device 3 includes application unit 23 that activates a first application for displaying the first in-vehicle image and a second application for displaying the second in-vehicle image including an amount of information less than an amount of information of the first in-vehicle image. Application unit 23 activates the first application when mobile terminal 5 is not communicatively connected to in-vehicle display device 3.

With this, when mobile terminal 5 is not connected to in-vehicle display device 3, the first in-vehicle image that is highly functional (with a larger amount of information than the second in-vehicle image) can be presented to the passenger by activating the first application.

Moreover, in-vehicle display device 3 according to technique 3 of the present embodiment is in-vehicle display device 3 according to technique 2. In this case, when mobile terminal 5 is communicatively connected to in-vehicle display device 3: application unit 23 stops the first application and activates the second application; and display controller 31 switches display from the in-vehicle image to the terminal image.

With this, when mobile terminal 5 is communicatively connected to in-vehicle display device 3, the terminal image can be displayed on in-vehicle display terminal 50. Moreover, since it is possible to stop the first application including a larger amount of information, activate the second application including a less amount of information and place the second application on standby, it is possible to inhibit an increase in resource in in-vehicle display device 3 compared to when the first application is activated and placed on standby.

Moreover, the second application having less resources than the first application runs in the background, so that it is possible to immediately switch from the terminal image to a second in-vehicle image of the second application even when a failure in rendering of the terminal image occurs. Therefore, even when a failure occurs in the display of information provided from mobile terminal 5 to the passenger via vehicle display terminal 50, the information can be immediately displayed. Accordingly, it is possible to continuously present information to the passenger and to prevent the safety of traveling vehicle 2 from being reduced.

Moreover, in-vehicle display device 3 according to technique 4 of the present embodiment is in-vehicle display device 3 according to technique 3. In this case, when failure detector 42 detects the render failure in the process of generating the terminal image after the second application is activated, and display controller 31 switches the display from the terminal image to the second in-vehicle image and causes in-vehicle display terminal 50 to display the second in-vehicle image: application unit 23 activates the first application; display controller 31 switches the display from the second in-vehicle image to the first in-vehicle image after the first application is fully activated; and application unit 23 stops the second application.

With this, when a render failure is detected, it is possible to switch from the terminal image to the second in-vehicle image of the second application that has been activated in advance, so that information can be displayed immediately.

In addition, display controller 31 starts activating the first application, but is capable of causing in-vehicle display terminal 50 to display the second in-vehicle image even during a short period of time before the first application is fully activated. Therefore, it is possible to continue presenting information necessary to the passenger even when a render failure occurs.

In addition, the first application is activated and the second in-vehicle image can be switched to the first in-vehicle image after the first application is activated, so that the display period of the second in-vehicle image that includes a less amount of information can be made as short as possible. This allows information to be displayed appropriately.

Moreover, after switching to the first in-vehicle image, the second application, which is no longer needed, can be stopped, so that an increase in resource of in-vehicle devices 10, 10a, 10b, and 10c is inhibited.

Moreover, in-vehicle display device 3 according to technique 5 of the present embodiment is in-vehicle display device 3 according to any one of techniques 2 to 4. In this case, failure detector 42 further detects a communication connection status between mobile terminal 5 and in-vehicle display device 3, and in-vehicle display terminal 50 displays, based on a presence or an absence of the render failure in the process of generating the terminal image and the communication connection status, whether a failure that is occurring is due to a failure in the communication connection status between mobile terminal 5 and in-vehicle display device 3 or the render failure in the process of generating the terminal image.

With this, it is possible to notify the passenger of whether the failure is due to a failure in communication connection status or a render failure in the process of generating the terminal image, so that the passenger can be notified of which problem is occurring. By understanding the content of the failure, the passenger is able to take action to fix the failure.

In-vehicle display device 3 according to technique 6 of the present embodiment is in-vehicle display device 3 according to any one of techniques 1 to 5. In this case, in-vehicle display device 3 further includes: a plurality of failure detectors 42 (failure detectors 42 of a plurality of monitoring devices 40a and 40b); and connection status manager 33 that manages, based on results output from the plurality of failure detectors 42 (failure detectors 42 of the plurality of monitoring devices 40a and 40b), display of the terminal image or the in-vehicle image on each of a plurality of in-vehicle display terminals 50a and 50b.

With this, connection status manager 33 is capable of determining whether to continue displaying the terminal image or to switch from the terminal image to the in-vehicle image, for example, taking into account the results output from the plurality of monitoring devices 40a and 40b. This increases the reliability of determination as to whether a render failure in the process of generating the terminal image has occurred.

In-vehicle display device 3 according to technique 7 of the present embodiment is in-vehicle display device 3 according to technique 6. In this case, when the terminal image rendered includes no change for at least a predetermined period and connection status manager 33 obtains, from at least one of the plurality of failure detectors 42 (failure detectors 42 of the plurality of monitoring devices 40a and 40b), a result indicating a detection of an occurrence of the render failure, and no render failure is indicated by an other result that is different from the result, connection status manager 33 determines that the terminal image rendered simply includes no change and no render failure is occurring in the process of generating the terminal image, and causes each of the plurality of in-vehicle display terminals 50a and 50b to continue displaying the terminal image.

With this, even when a plurality of monitoring devices 40a and 40b incorrectly determine that a render failure is occurring because there is no change in the rendered terminal images for a long period of time, connection status manager 33 is capable of determining that no render failure is occurring when the other results indicate no render failure. This increases the reliability of the determination as to whether a render failure has occurred in the process of generating the terminal image.

In-vehicle display device 3 according to technique 8 of the present embodiment is in-vehicle display device 3 according to technique 6 or 7. In this case, connection status manager 33 causes a plurality of display controllers 31a and 31b each of which is the display controller to switch the image to be displayed from the terminal image to the in-vehicle image and causes each of the plurality of in-vehicle display terminals 50a and 50b to display the in-vehicle image, when the results output from the plurality of failure detectors 42 (failure detectors 42 of the plurality of monitoring devices 40a and 40b) include at least a predetermined number of results each indicating a detection of an occurrence of the render failure.

With this, when the number of results indicating an occurrence of a render failure is greater than or equal to a predetermined threshold value, it is considered that a failure is occurring in all of the rendered terminal images, or that a failure is likely to occur in the future. Hence, all terminal images can be switched to the in-vehicle images and the in-vehicle images can be displayed on in-vehicle display terminals 50a and 50b. Therefore, according to in-vehicle display device 3, information can be displayed appropriately.

Moreover, in-vehicle display device 3 according to technique 9 of the present embodiment is in-vehicle display device 3 according to any one of techniques 6 to 8. In this case, connection status manager 33 causes a notifier (in-vehicle display terminals 50a, 50b and the like) provided to vehicle 2 to notify a content of a failure that has occurred, when connection status manager 33 obtains, from at least one of the plurality of failure detectors 42, a result indicating a detection of an occurrence of the render failure.

With this, it is possible to notify the content of the failure that has occurred. Therefore, the passenger is able to understand the content of the failure and take action to fix the failure.

Moreover, an in-vehicle display method according to technique 10 of the present embodiment is an in-vehicle display method for causing in-vehicle display terminal 50 provided to vehicle 2 to display one of an in-vehicle image that is an image related to in-vehicle device 10, 10a, 10b, 10c provided to vehicle 2 or a terminal image that is an image output from mobile terminal 5 carried by a passenger of vehicle 2. The in-vehicle display method includes: obtaining, by first image obtainer 11, the terminal image from mobile terminal 5; obtaining, by second image obtainer 21, the in-vehicle image from in-vehicle devices 10, 10a, 10b, 10c; detecting, by failure detector 42, a render failure in a process of generating the terminal image; and switching, by display controller 31, an image to be displayed from the terminal image to the in-vehicle image and causing, by display controller 31, in-vehicle display terminal 50 to display the in-vehicle image, when failure detector 42 detects the render failure in the process of generating the terminal image.

This method also produces the same effects as described above.

A program according to technique 11 of the present embodiment is a program for causing a computer to execute the in-vehicle display method according to technique 10.

The method also provides the same actions and effects described above.

### (Other Variations)

Although the in-vehicle display device, the in-vehicle display method, and the program according to the present disclosure have been described based on the embodiment described above, the present disclosure is not limited to the embodiment. The forms obtained by various modifications to the embodiment that can be conceived by a person of skill in the art within the scope of the essence of the present disclosure may also be included in the present disclosure.

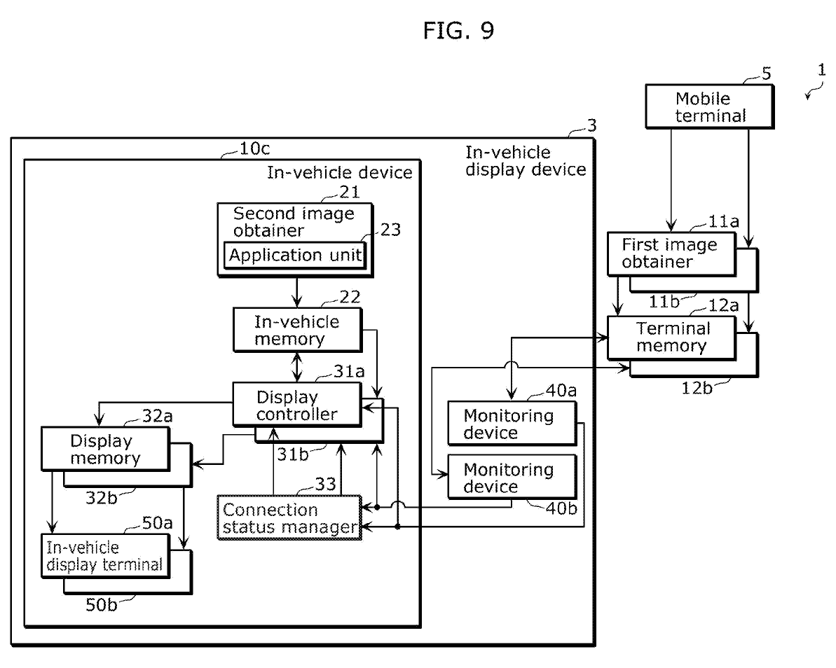

For example, display control system 1 according to the embodiment may include the configuration illustrated in FIG. 9. FIG. 9 is another block diagram illustrating display control system 1 according to another variation. As illustrated in FIG. 9, the plurality of first image obtainers 11a and 11b and the plurality of terminal memories 12a and 12b do not have to be included in vehicle device 10c. In this case, the plurality of first image obtainers 11a and 11b and the plurality of terminal memories 12a and 12b may be included in mobile terminal 5 or may be separate and independent from mobile terminal 5.

Each structural element in the in-vehicle device, the monitoring device and the like included in the in-vehicle display device according to the embodiment is implemented as a large scale integration (LSI) which is typically an integrated circuit. They may be individually configured as single chips or may be configured so that part or all are included in a single chip.

The method of circuit integration is not limited to LSIs, and implementation through a dedicated circuit or a general-purpose processor is also possible. A field programmable gate array (FPGA) that can be programmed after the LSI is manufactured or a reconfigurable processor in which the connection and settings of circuit cells inside the LSI can be reconfigured may be used.

In the embodiment described above, each structural element may be configured in the form of a dedicated hardware product or realized by executing a software program suitable for each structural element. Each of the structural elements may be realized by means of a program executing unit, such as a central processing unit (CPU) and a processor, reading and executing the software program recorded on a recording medium, such as a hard disk or a semiconductor memory.

Moreover, all numerical figures used in the forgoing description are merely examples for describing the present disclosure in specific terms, and thus the embodiment according to the present disclosure is not limited to the illustrated numerical figures.

Furthermore, the separation of the function blocks in the block diagrams is merely an example, and plural function blocks may be implemented as a single function block, a single function block may be separated into plural function blocks, or part of functions of a function block may be transferred to another function block. Furthermore, the functions of function blocks having similar functions may be processed in parallel or in a time division manner by a single hardware or software.

Moreover, the sequence in which the above-described steps included in the flowcharts are executed is given as an example to describe the present disclosure in specific terms, and thus other sequences are possible. Part of the above-described steps may be executed simultaneously (in parallel) with another step.

Various modifications to the present embodiment that can be conceived by those skilled in the art, and forms configured by combining the structural elements and functions in the embodiment without departing from the teachings of the present disclosure are also included in the present disclosure.

Further Information about Technical Background to this Application

The disclosure of the following patent application including specification, drawings, and claims is incorporated herein by reference in their entirety: Japanese Patent Application No. 2024-170176 filed on September 30, 2024.

### Industrial Applicability

The in-vehicle display device, the in-vehicle display method, and the program according to the present disclosure are applicable to, for example, a vehicle that includes one or more display devices, and a device and a system other than the vehicle.

1. An in-vehicle display device that causes an in-vehicle display terminal provided to a vehicle to display one of an in-vehicle image that is an image related to an in-vehicle device provided to the vehicle or a terminal image that is an image output from a mobile terminal carried by a passenger of the vehicle, the in-vehicle display device comprising:
a first image obtainer that obtains the terminal image from the mobile terminal;
a second image obtainer that obtains the in-vehicle image from the in-vehicle device;
a failure detector that detects a render failure in a process of generating the terminal image; and
a display controller that switches an image to be displayed from the terminal image to the in-vehicle image and causes the in-vehicle display terminal to display the in-vehicle image, when the failure detector detects the render failure in the process of generating the terminal image.

2. The in-vehicle display device according to claim 1,
wherein the in-vehicle image includes a first in-vehicle image and a second in-vehicle image,
the in-vehicle display device includes an application unit that activates a first application for displaying the first in-vehicle image and a second application for displaying the second in-vehicle image including an amount of information less than an amount of information of the first in-vehicle image, and
the application unit activates the first application when the mobile terminal is not communicatively connected to the in-vehicle display device.

3. The in-vehicle display device according to claim 2,
wherein, when the mobile terminal is communicatively connected to the in-vehicle display device:
the application unit stops the first application and activates the second application; and
the display controller switches display from the in-vehicle image to the terminal image.

4. The in-vehicle display device according to claim 3,
wherein, when the failure detector detects the render failure in the process of generating the terminal image after the second application is activated, and the display controller switches the display from the terminal image to the second in-vehicle image and causes the in-vehicle display terminal to display the second in-vehicle image:
the application unit activates the first application;
the display controller switches the display from the second in-vehicle image to the first in-vehicle image after the first application is fully activated; and
the application unit stops the second application.

5. The in-vehicle display device according to claim 2,
wherein the failure detector further detects a communication connection status between the mobile terminal and the in-vehicle display device, and
the in-vehicle display terminal displays, based on a presence or an absence of the render failure in the process of generating the terminal image and the communication connection status, whether a failure that is occurring is due to a failure in the communication connection status between the mobile terminal and the in-vehicle display device or the render failure in the process of generating the terminal image.

6. The in-vehicle display device according to claim 1, further comprising:
a plurality of failure detectors each of which is the failure detector; and
a connection status manager that manages, based on results output from the plurality of failure detectors, display of the terminal image or the in-vehicle image on each of a plurality of in-vehicle display terminals each of which is the in-vehicle display terminal.

7. The in-vehicle display device according to claim 6,
wherein, when the terminal image rendered includes no change for at least a predetermined period and the connection status manager obtains, from at least one of the plurality of failure detectors, a result indicating a detection of an occurrence of the render failure, and when no render failure is indicated by an other result that is different from the result, the connection status manager determines that the terminal image rendered simply includes no change and no render failure is occurring in the process of generating the terminal image, and causes each of the plurality of in-vehicle display terminals to continue displaying the terminal image.

8. The in-vehicle display device according to claim 6,
wherein the connection status manager causes a plurality of display controllers each of which is the display controller to switch the image to be displayed from the terminal image to the in-vehicle image and causes each of the plurality of in-vehicle display terminals to display the in-vehicle image, when the results output from the plurality of failure detectors include at least a predetermined number of results each indicating a detection of an occurrence of the render failure.

9. The in-vehicle display device according to claim 6,
wherein the connection status manager causes a notifier provided to the vehicle to notify a content of a failure that has occurred, when the connection status manager obtains, from at least one of the plurality of failure detectors, a result indicating a detection of an occurrence of the render failure.

10. An in-vehicle display method for causing an in-vehicle display terminal provided to a vehicle to display one of an in-vehicle image that is an image related to an in-vehicle device provided to the vehicle or a terminal image that is an image output from a mobile terminal carried by a passenger of the vehicle, the in-vehicle display method comprising:
obtaining, by a first image obtainer, the terminal image from the mobile terminal;
obtaining, by a second image obtainer, the in-vehicle image from the in-vehicle device;
detecting, by a failure detector, a render failure in a process of generating the terminal image; and
switching, by a display controller, an image to be displayed from the terminal image to the in-vehicle image when the failure detector detects the render failure in the process of generating the terminal image, and causing, by the display controller, the in-vehicle display terminal to display the in-vehicle image.

11. A non-transitory computer-readable storage medium having stored thereon a program for causing a computer to execute the in-vehicle display method according to claim 10.
